(19) United States
(12) Patent Application Publication
(10) Pub. No.: US 2019/0018255 A1
(43) Pub. Date: Jan. 17, 2019

(54) COMPACT NEAR-EYE OPTICAL SYSTEM INCLUDING A REFRACTIVE BEAM-SPLITTING CONVEX LENS

(71) Applicant: Google LLC, Mountain View, CA (US)

(72) Inventors: Yi QIN, Mountain View, CA (US); Serge BIERHUIZEN, San Jose, CA (US); Xinda HU, Mountain View, CA (US); Jerome CAROLLO, Mountain View, CA (US)

(21) Appl. No.: 15/954,172

(22) Filed: Apr. 16, 2018

Related U.S. Application Data
(60) Provisional application No. 62/531,225, filed on Jul. 11, 2017.

(51) Int. Cl. G02B 27/26; G02B 27/12

(52) U.S. Cl. CPC G02B 27/26; G02B 27/123

(57) ABSTRACT

An optical system includes a first filter stack to convert light to a first circular polarization, and a second filter stack that reflects light having the first circular polarization and transmits light having a second circular polarization. A refractive beam splitting convex lens is disposed intermediate the first filter stack and the second filter stack. The first filter stack can include a first linear polarizer to convert light to a first linear polarization and a first quarter wave plate to convert the light from the first linear polarization to a first circular polarization. The second filter stack can include a second quarter wave plate to convert the light from the first circular polarization to a second linear polarization that is transverse to the first linear polarization, a polarization-dependent beam splitter to pass the first polarization and reflect the second polarization, and a linear polarizer to pass the second polarization.

### CROSS REFERENCE TO RELATED APPLICATIONS

This application claims priority to U.S. Provisional Patent Application 62/531,225 entitled “A Compact Near-Eye Optical System Including A Refractive Beam-Splitting Convex Lens,” which was filed on Jul. 11, 2017 and is incorporated herein by reference in its entirety.

### BACKGROUND

Immersive virtual reality (VR) and augmented reality (AR) systems typically utilize a head mounted display (HMD) device that presents stereoscopic imagery to the user so as to give a sense of presence in a three-dimensional (3D) scene. Conventional HMD devices implement either a single flat display that is separated into two independent display regions, one for the left eye and one for the right eye of the user, or a pair of independent flat displays, one for each eye of the user. The conventional HMD also includes an optical system that focuses the entire image of the display into the user's eyes. The optical system includes singlet lenses, such as aspheric lenses or Fresnel lenses, which have focal lengths of about 35 millimeters (mm) or more. Neither type of lens provides the level of optical performance required for a high-quality VR or AR experience. Singlet aspheric lenses generate a relatively large amount of chromatic aberration, field curvature, and astigmatism. Fresnel lenses generate a relatively large amount of chromatic aberration and they produce Fresnel artifacts, such as stray light from total internal reflection on the Fresnel facets and ghost images due to manufacturing errors at the Fresnel facets.

Furthermore, singlet lenses such as aspheric lenses and Fresnel lenses have a relatively long back focal distance, which increases the distance between the lens and the display. Long back focal distances result in a bulky, front-heavy HMD that has a high moment of inertia. The singlet lens can be constructed with a shorter lens focal length. However, the lens magnification is inversely proportional to the lens focal length. The lens magnification therefore increases as the lens focal length decreases. Depending on the pixel resolution of the display, increasing the lens magnification can cause the viewer to perceive pixelation in the magnified image of the display. Furthermore, short focal length magnifiers are more difficult to design, typically require more optical elements to manage increasing optical aberrations, and are sensitive to optical/mechanical tolerances and eye positioning.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram of a first example of an optical system that collimates light received from a display to provide substantially parallel light rays to an eye of a user according to some embodiments.

FIG. 2 is a diagram of a second example of an optical system that collimates light received from a display according to some embodiments.

FIG. 3 is a diagram of a third example of an optical system that collimates light received from a display according to some embodiments.

FIG. 4 is a diagram of a fourth example of an optical system that collimates light received from a display according to some embodiments.

FIG. 5 illustrates a display system that includes an electronic device configured to provide virtual reality, augmented reality, or mixed reality functionality via a display according to some embodiments.

### DETAILED DESCRIPTION

Polarization-dependent beam splitters can be used to fold the light path and reduce the dimensions of a near-eye optical system implemented in an HMD. For example, an inline, or “pancake,” viewer includes a linear polarizer to receive light from a display, a quarter wave plate to convert the light to right circular polarization, a spherical reflective beam splitter (which is implemented as, for example, a focusing concave mirror having a half silvered surface), a quarter wave plate to convert the right circular polarization to vertical linear polarization, a polarization-dependent beam splitter to reflect vertical polarization and pass horizontal polarization, and a linear polarizer to pass the horizontal polarization. The in-line viewer concentrates optical power at the spherical reflective beam splitter to improve management of optical aberrations including coma, astigmatism, and chromatic aberration. However, the in-line viewer is optimized for micro displays (e.g., displays having a diagonal of approximately one inch) and it is difficult to scale the design directly to larger displays (e.g., displays having a diagonal of approximately 1.5-3 inches per channel). The challenges include correcting for strong field curvature produced by the spherical reflective beam splitter and the larger size of the spherical reflective beam splitter that is needed to correct for aberration in images produced by the larger displays.

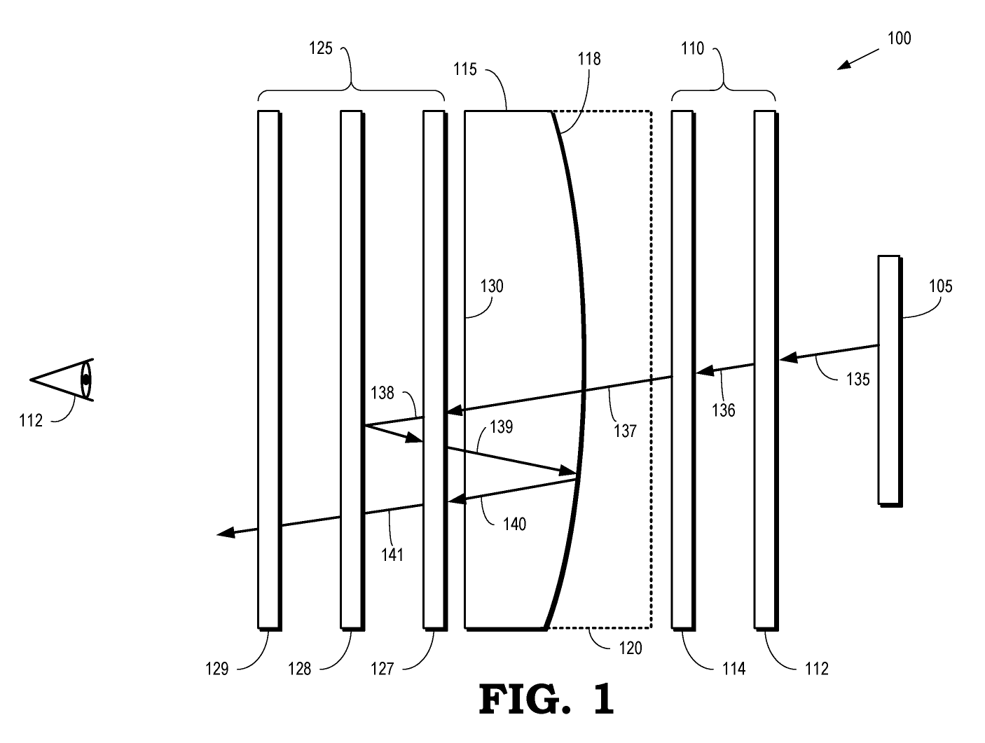

FIGS. 1-5 describe embodiments of a compact near-eye optical system that has improved optical performance, reduced ghosting, and a larger field-of-view relative to an in-line pancake viewer. The optical system includes a first linear polarizer to convert light from a display to a first linear polarization, a first quarter wave plate to convert the linear polarized light to a first circular polarization, a refractive beam splitting convex lens, a second quarter wave plate to convert the first circular polarization to a second linear polarization (which is transverse to the first linear polarization), a polarization-dependent beam splitter to pass the first polarization and reflect the second polarization, and a linear polarizer to pass the second polarization. The refractive beam splitting convex lens can be implemented as a plano-convex lens having one planar surface and an opposing convex surface or a bi-convex lens having two opposed convex surfaces.

Replacing the conventional spherical reflective beam splitter with a refractive beam splitting convex lens provides a number of improvements to the optical system. Embodiments of the optical system including the refractive beam splitting convex lens typically produce lower optical aberration, which allows the user to resolve smaller display pixels and supports a larger eyebox. The optical system also produces lower levels of spherical and chromatic aberration, astigmatism, and coma. The refractive portion of the refractive beam splitting convex lens balances the field curvature of the reflective portion, thereby reducing the overall field curvature produced by the optical system. Furthermore, the additional refractive power of the refractive beam splitting convex lens can be varied to enhance, optimize, or tune the optical performance of the optical system. In some embodiments, the second quarter wave plate is bonded to the planar surface of a plano-convex lens used to implement the refractive beam splitting convex lens, thereby reducing the number of air gaps that can produce ghost images due to internal reflections.

FIG. 1 is a diagram of a first example of an optical system 100 that collimates light received from a display 105 to provide substantially parallel light rays to an eye 110 of a user according to some embodiments. The optical system 100 includes a first filter stack 110 that receives light from the display 105. Some embodiments of the filter stack 110 include a linear polarizer 112 that converts the received light to a first linear polarization. For example, the linear polarizer 112 can convert unpolarized (or partially polarized) light to light that is polarized in a direction that is in the plane of the drawing, which is referred to herein as the y-direction. The filter stack 110 also includes a quarter wave plate 114 that converts linear polarized light into a first circular polarization. For example, the quarter wave plate 114 can convert light polarized in the y-direction to right circularly polarized light. Some embodiments of the filter stack 110 are integrated with the display 105. For example, the linear polarizer 112 can be laminated to a surface of the display 105. However, in other embodiments, the first filter stack 110 is separated from the display 105 by an air gap.

The optical system 100 also includes a refractive beam splitting convex lens 115 that is formed of a material having a first refractive index and a beam splitting coating. For example, the refractive beam splitting convex lens 115 can be formed of glass or plastic and a convex surface 118 of the refractive beam splitting convex lens 115 can be a half-silvered surface. Some embodiments of the refractive beam splitting convex lens 115 have a focal length in the range of 150 mm to 300 mm. For example, the focal length of the refractive beam splitting convex lens 115 can be within the range of 180 mm to 280 mm. Some embodiments of the refractive beam splitting convex lens 115 are separated from the filter stack 110 by an air gap. In some embodiments, the optical system 100 also includes another refractive element 120 that includes a concave surface that matches the curvature of the convex surface 118 and has a second refractive index that differs from the first refractive index. Incorporating the additional refractive element 120 provides additional optical parameters that can be tuned to improve the optical performance of the optical system 100.

The optical system 100 includes a second filter stack 125 that transmits light having a first polarization and reflects light having a second polarization that is orthogonal to the first polarization. For example, the second filter stack 125 can be configured to transmit light having left circular polarization and reflect light having right circular polarization. Some embodiments of the second filter stack 125 include a quarter wave plate 127 that converts circularly polarized light into linearly polarized light. For example, the quarter wave plate 127 can convert right circularly polarized light into light that is polarized in the y-direction and the quarter wave plate 127 can convert left circularly polarized light into light that is polarized in a direction perpendicular to the plane of the drawing, which is referred to herein as the x-direction and which is orthogonal or transverse to the y-direction. The second filter stack 125 also includes a polarization-dependent beam splitter 128 that transmits light polarized in a first direction and reflects light polarized in a second direction that is orthogonal or transverse to the first direction. For example, the polarization dependent beam splitter 128 can reflect light polarized in the y-direction and transmit light polarized in the x-direction. Some embodiments of the second filter stack 125 also include a linear polarizer 129 that transmits linearly polarized light. For example, the linear polarizer 129 can transmit light polarized in the x-direction.

Some embodiments of the second filter stack 125 are bonded to a planar surface 130 of the refractive beam splitting convex lens 115. For example, the quarter wave plate 127 can be laminated to the planar surface 130. Bonding the second filter stack 125 to the refractive beam splitting convex lens 115 as a number of advantages, including reduced size of the optical system 100, a larger field-of-view, a reduced number of Fresnel reflections (or ghost images) produced at optical surfaces in the optical system 100, and the like. In other embodiments, the second filter stack 125 is separated from the refractive beam splitting convex lens 115 by an air gap.

Folding of the optical path in the optical system 100 is illustrated by following the propagation of a light ray 135 that is generated by the display 105. Initially, the light ray 135 that emerges from the display 105 is unpolarized or partially polarized. The linear polarizer 112 converts the light ray 135 into a linearly polarized light ray 136. For example, the light ray 136 can be polarized in the y-direction. The quarter wave plate 114 converts the linearly polarized light ray 136 into a light ray 137 having a first circular polarization. For example, the quarter wave plate 114 can convert the light ray 136 from a linear polarization in the y-direction to the light ray 137 that is right circularly polarized. The convex surface 118 transmits a portion of the circularly polarized light ray 137, which is then refracted within the refractive beam splitting convex lens 115 before being provided to the quarter wave plate 127. The circularly polarized light ray 137 is converted to a linearly polarized light ray 138 by the quarter wave plate 127. For example, the quarter wave plate 127 can convert a right circularly polarized light ray 137 into a light ray 138 that is linearly polarized in the y-direction. The light ray 138 is reflected by the polarization dependent beam splitter 128 and converted to a circularly polarized light ray 139 by the quarter wave plate 127. For example, the light ray 139 can be right circularly polarized. The light ray 139 is refracted by the refractive beam splitting convex lens 115 and a portion of the light ray 139 reflects from the convex surface 118. Reflection reverses the circular polarization of the light ray 139, e.g., reflection converts the light ray 139 to a left circularly polarized light ray 140. The quarter wave plate 127 converts the circularly polarized light ray 140 into a linearly polarized light ray 141. For example, the left circular polarization of the light ray 140 is converted into linear polarization of the light ray 141 in the x-direction. The polarization dependent beam splitter 128 and the linear polarizer 129 transmit the linearly polarized light ray 141.

The optical system 100 including the refractive beam splitting convex lens 115 has a number of advantages over conventional optical systems. The optical system 100 generates fewer optical aberrations because the convex surface 118 provides reflecting optical power and refraction power as light rays propagate from the display 105 to the eye 112 of the user, which allows the user to resolve smaller display pixels. The optical system 100 also provides a larger eye box, which reduces “pupil swimming.” Spherical aberration, chromatic aberration, astigmatism, and coma are all reduced relative to optical systems that include reflective beam splitters. Moreover, the positive refractive power in the refractive beam splitting convex lens 115 balances the field curvature of the convex surface 118. In some embodiments, the optical system only implements a single optical element, e.g., the refractive beam splitting convex lens 115, which simplifies fabrication of the optical system 100.

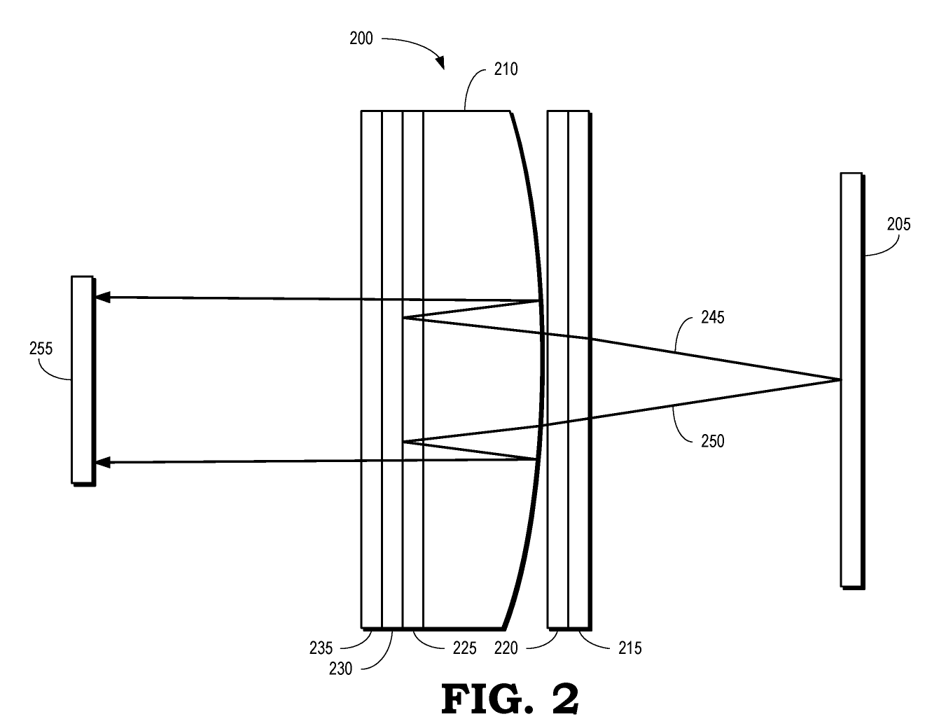

FIG. 2 is a diagram of a second example of an optical system 200 that collimates light received from a display 205 according to some embodiments. The optical system 200 includes a refractive beam splitting convex lens 210 that is disposed between two filter stacks. The first filter stack includes a linear polarizer 215 and a quarter wave plate 220. The second filter stack includes a quarter wave plate 225, a polarization dependent beam splitter 230, and a linear polarizer 235. In the illustrated embodiment, the first filter stack is disposed proximate to a curved surface of the refractive beam splitting convex lens 210 and an air gap is provided between a planar surface of the quarter wave plates 220 and the curved surface of the refractive beam splitting convex lens 210. The first filter stack is separated from the display 205 by an air gap. The second filter stack is disposed on a planar surface of the refractive beam splitting convex lens 210. For example, the second filter stack can be laminated to the planar surface of the refractive beam splitting convex lens 210.

Light rays that emanate from the same point on the display 205 are collimated by the optical system 200 to emerge substantially parallel to each other. For example, light rays 245, 250 emerge from the same pixel in the display 205. As discussed herein, the light rays 245, 250 are transmitted by the first filter stack and the curved surface of the refractive beam splitting convex lens 210, refracted in the refractive beam splitting convex lens 210, reflected by the second filter stack, refracted in the refractive beam splitting convex lens 210, reflected by the curved surface of the refractive beam splitting convex lens 210, and then transmitted by the second filter stack. The light rays 245, 250 are substantially parallel when they emerge from the optical system 200 and arrive at a detection plane 255, which corresponds to an eye of the user in some cases.

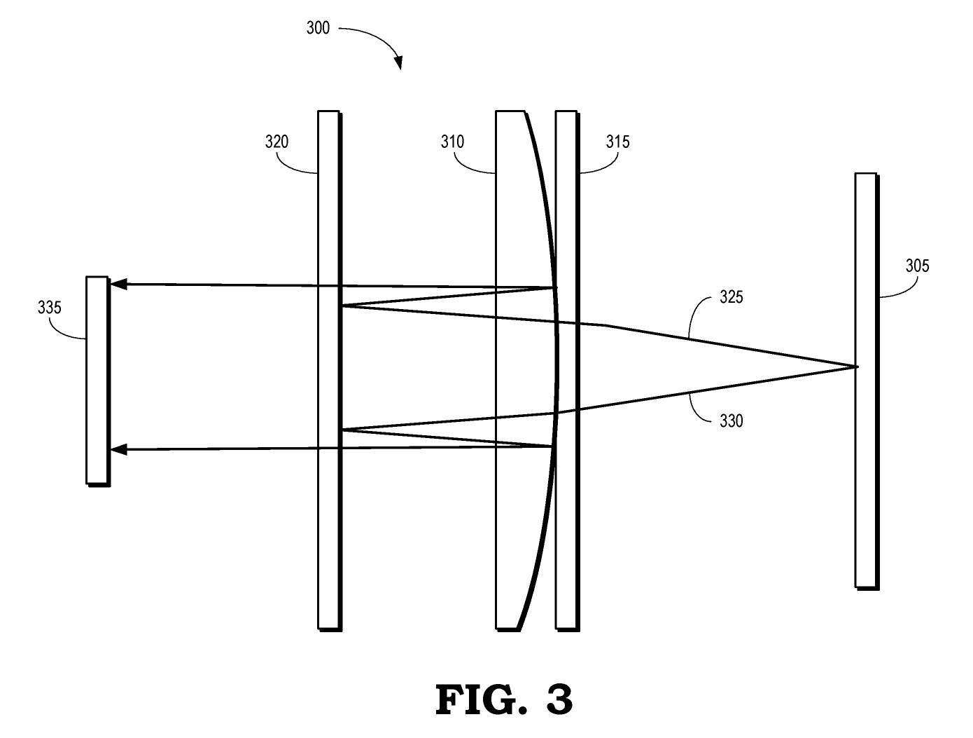

FIG. 3 is a diagram of a third example of an optical system 300 that collimates light received from a display 305 according to some embodiments. The optical system 300 includes a refractive beam splitting convex lens 310 that is disposed between a first filter stack 315 and a second filter stack 320. Some embodiments of the first and second filter stacks 315, 320 include the same components as the first and second filter stacks 110, 125 shown in FIG. 1 and the first and second filter stacks shown in FIG. 2. The third example of the optical system 300 differs from the second example of the optical system 200 shown in FIG. 2 because the second filter stack 320 is displaced from the planar surface of the refractive beam splitting convex lens 310 along an optical axis of the optical system 300. In some embodiments, the second filter stack 320 is separated from the planar surface of the refractive beam splitting convex lens 310 by an air gap.

Light rays that emanate from the same point on the display 305 are collimated by the optical system 300 to emerge substantially parallel to each other. For example, light rays 325, 330 emerge from the same pixel in the display 305. As discussed herein, the light rays 325, 330 are transmitted by the first filter stack 315 and the curved surface of the refractive beam splitting convex lens 310, refracted in the refractive beam splitting convex lens 310, reflected by the second filter stack 320, refracted in the refractive beam splitting convex lens 310, reflected by the curved surface of the refractive beam splitting convex lens 310, and then transmitted by the second filter stack 320. The light rays 325, 330 are substantially parallel when they emerge from the optical system 300 and arrive at a detection plane 335, which corresponds to an eye of the user in some cases.

Separating the second filter stack 320 from the planar surface of the refractive beam splitting convex lens 310 has a number of advantages relative to other embodiments that dispose the second filter stack on the planar surface. Splitting the second filter stack 320 from the planar surface creates a telecentric display space that allows better focus adjustment of the optical system 300. Image magnification and distortion remains constant when the display 305 is shifted axially for focus adjustment while still providing a wide field of view. Furthermore, the total length of the optical path can be reduced because the light path is folded between the first and second filter stacks 315, 320.

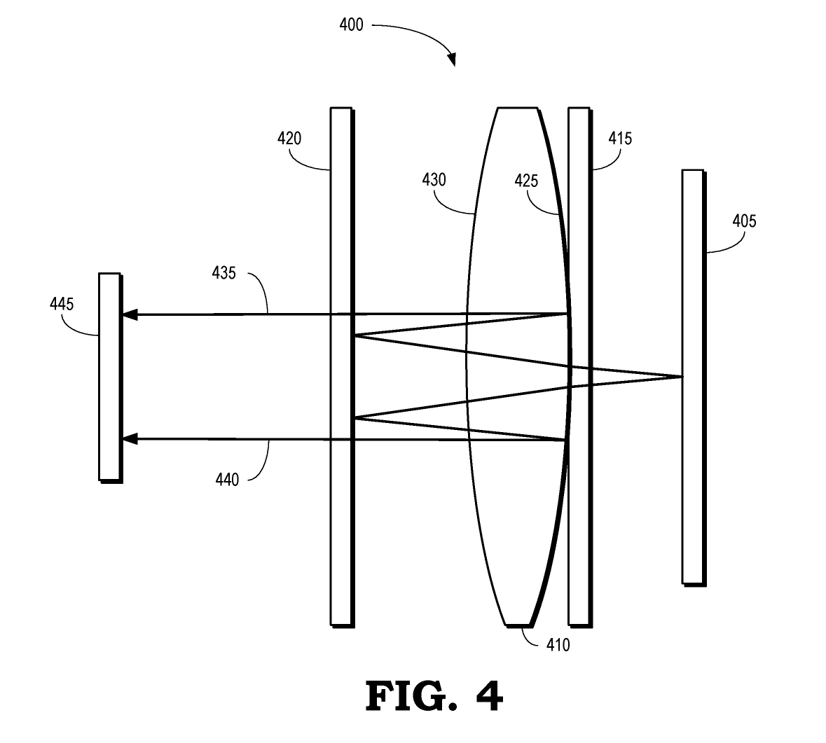

FIG. 4 is a diagram of a fourth example of an optical system 400 that collimates light received from a display 405 according to some embodiments. The optical system 400 includes a refractive beam splitting convex lens 410 that is disposed between a first filter stack 415 and a second filter stack 420. Some embodiments of the first and second filter stacks 415, 420 include the same components as the first and second filter stacks 110, 125 shown in FIG. 1 and the first and second filter stacks shown in FIG. 2. The fourth example of the optical system 400 differs from the third example of the optical system 300 shown in FIG. 3 because the refractive beam splitting convex lens 410 is implemented as a bi-convex lens having two opposed convex surfaces 425, 430. As discussed herein, light rays 435, 440 emanating from the same point on the display 405 are substantially parallel when they emerge from the optical system 400 and arrive at a detection plane 445, which corresponds to an eye of the user in some cases. The bi-convex lens implemented for the refractive beam splitting convex lens 410 provides an additional surface (e.g., the convex surface 430) that can be configured to provide additional optical correction, adjustment, or tuning relative to optical systems that include a plano-convex lens such as the refractive beam splitting lens 310 shown in FIG. 3.

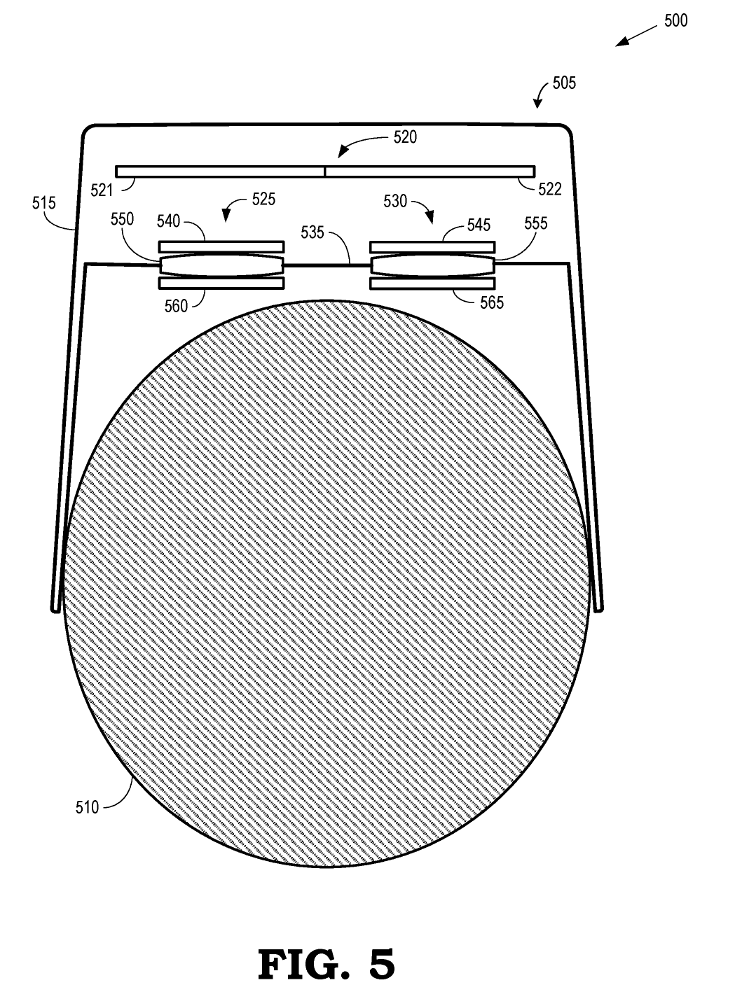

FIG. 5 illustrates a display system 500 that includes an electronic device 505 configured to provide virtual reality, augmented reality, or mixed reality functionality via a display according to some embodiments. The illustrated embodiment of the electronic device 505 can include a portable user device, such as an HMD, a tablet computer, computing-enabled cellular phone (e.g., a “smartphone”), a notebook computer, a personal digital assistant (PDA), a gaming console system, and the like. In other embodiments, the electronic device 505 can include a fixture device, such as medical imaging equipment, a security imaging sensor system, an industrial robot control system, a drone control system, and the like. For ease of illustration, the electronic device 505 is generally described herein in the example context of an HMD system; however, the electronic device 505 is not limited to these example implementations.

The electronic device 505 is shown in FIG. 5 as being mounted on a head 510 of a user. As illustrated, the electronic device 505 includes a housing 515 that includes a display 520 that generates an image for presentation to the user. The display 520 can be used to implement some embodiments of the display 105 shown in FIG. 1, the display 205 shown in FIG. 2, the display 305 shown in FIG. 3, and the display 405 shown in FIG. 4. In the illustrated embodiment, the display 520 is formed of a left display 521 and a right display 522 that are used to display stereoscopic images to corresponding left eye and right eye. However, in other embodiments, the display 520 is a single monolithic display 520 that generates separate stereoscopic images for display to the left and right eyes.

The electronic device 505 also includes eyepiece optical systems 525, 530 disposed in corresponding apertures or other openings in a user-facing surface 535 of the housing 515. In the illustrated embodiment, the eyepiece optical systems 525, 530 include first filter stacks 540, 545, which can be formed using a linear polarizer and a quarter wave plate, as discussed herein. The eyepiece optical systems 525, 530 also include refractive beam splitting convex lenses 550, 555, which can be plano-convex or bi-convex, as discussed herein. The eyepiece optical systems 525, 530 further include second filter stacks 560, 565, which can be formed using a quarter wave plate, a polarization dependent beam splitter, and a linear polarizer, as discussed herein. The display 520 is disposed distal to the eyepiece optical systems 525, 530 within the housing 515. The eyepiece optical system 525 is aligned with the left eye display 521 and the eyepiece optical system 530 is aligned with the right eye display 522.

In a stereoscopic display mode, imagery is displayed by the left eye display 521 and viewed by the user's left eye via the eyepiece optical system 525. Imagery is concurrently displayed by the right eye display 522 and viewed by the user's right eye via the eyepiece optical system 530. The imagery viewed by the left and right eyes is configured to create a stereoscopic view for the user. Some embodiments of the displays 520, 521, 522 are fabricated to include a bezel (not shown in FIG. 5) that encompasses one or more outer edges of the displays 520, 521, 522. In that case, the eyepiece optical systems 525, 530 or other optical devices are used to combine the images produced by the displays 520, 521, 522 so that bezels around the displays 520, 521, 522 are not seen by the user. Instead, eyepiece optical systems 525, 530 merge the images to appear continuous across boundaries between the displays 520, 521, 522.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An apparatus comprising:
a first filter stack configured to convert light to a first circular polarization;
a second filter stack configured to reflect light having the first circular polarization and transmit light having a second circular polarization; and
a refractive beam splitting convex lens disposed between the first filter stack and the second filter stack.

2. The apparatus of claim 1, wherein the first filter stack comprises:
a first linear polarizer to convert light to a first linear polarization; and
a first quarter wave plate to convert the light from the first linear polarization to a first circular polarization.

3. The apparatus of claim 2, wherein the second filter stack comprises:
a second quarter wave plate to convert the light from the first circular polarization to a second linear polarization that is transverse to the first linear polarization;
a polarization-dependent beam splitter to pass the first linear polarization and reflect the second linear polarization; and
a linear polarizer to pass the second linear polarization.

4. The apparatus of claim 1, wherein the refractive beam splitting convex lens comprises a plano-convex lens having a planar surface and an opposing convex surface.

5. The apparatus of claim 4, wherein the second filter stack is laminated on the planar surface of the plano-convex lens.

6. The apparatus of claim 4, wherein the second filter stack is separated from the planar surface of the plano-convex lens by an air gap.

7. The apparatus of claim 1, wherein the refractive beam splitting convex lens comprises a bi-convex lens.

8. The apparatus of claim 7, wherein the bi-convex lens is separated from the second filter stack by an air gap.

9. The apparatus of claim 1, wherein the refractive beam splitting convex lens comprises a first portion having a first refractive index and a second portion having a second refractive index, and wherein the first portion and the second portion have corresponding convex and concave surfaces.

10. The apparatus of claim 1, further comprising:
a display configured to provide the light to the first filter stack, wherein the light represents an image.

11. The apparatus of claim 10, wherein the first filter stack is disposed on the display.

12. An apparatus comprising:
at least one display to generate first and second stereoscopic images for presentation to a left eye and a right eye, respectively, of a user; and
an optical system including a first portion to provide light representative of the first stereoscopic image to the left eye and a second portion to provide light representative of the second stereoscopic image to the right eye, wherein the first portion and the second portion include:
a first filter stack configured to convert light to a first circular polarization;
a second filter stack configured to reflect light having the first circular polarization and transmit light having a second circular polarization; and
a refractive beam splitting convex lens disposed between the first filter stack and the second filter stack.

13. The apparatus of claim 12, wherein the first filter stack comprises:
a first linear polarizer to convert light to a first linear polarization; and
a first quarter wave plate to convert the light from the first linear polarization to a first circular polarization.

14. The apparatus of claim 13, wherein the second filter stack comprises:
a second quarter wave plate to convert the light from the first circular polarization to a second linear polarization that is transverse to the first linear polarization;
a polarization-dependent beam splitter to pass the first linear polarization and reflect the second linear polarization; and
a linear polarizer to pass the second linear polarization.

15. The apparatus of claim 12, wherein the refractive beam splitting convex lens comprises a plano-convex lens having a planar surface and an opposing convex surface.

16. The apparatus of claim 15, wherein the second filter stack is laminated to the planar surface.

17. The apparatus of claim 12, wherein the refractive beam splitting convex lens comprises a bi-convex lens.

18. The apparatus of claim 12, wherein the refractive beam splitting convex lens is separated from the second filter stack by an air gap.

19. The apparatus of claim 12, wherein the refractive beam splitting convex lens comprises a first portion having a first refractive index and a second portion having a second refractive index, and wherein the first portion and the second portion have corresponding convex and concave surfaces.

20. The apparatus of claim 12, wherein the first filter stack is integrated with the at least one display.

21. A method comprising:
converting, at a first filter stack, light received from a display to a first circular polarization;
refracting, at a refractive beam splitting convex lens, the light in the first circular polarization and providing the light to a second filter stack;
reflecting, at the second filter stack, the light having the first circular polarization back to the refractive beam splitting convex lens;
reflecting, from a convex surface of the refractive beam splitting convex lens, the light having the first circular polarization so that the reflected light has a second circular polarization; and
transmitting, through the second filter stack, the reflected light having the second circular polarization.

22. The method of claim 21, wherein refracting the light at the refractive beam splitting convex lens comprises refracting the light at a plano-convex lens having a planar surface and an opposing convex surface.

23. The method of claim 21, wherein refracting the light at the refractive beam splitting convex lens comprises refracting the light at a bi-convex lens.
